(19) United States
(12) Patent Application Publication
(10) Pub. No.: US 2009/0000589 A1
(43) Pub. Date: Jan. 1, 2009

(54) Recreational vehicle engine design

(76) Inventors: Steven Weinzierl, New Richmond, WI (US); Michael J. Fuchs, New Richmond, WI (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/823,480

(22) Filed: Jun. 27, 2007

(51) Int. Cl. F02B 75/06

(52) U.S. Cl. 123/192.2

(57) ABSTRACT

A device for damping torsional vibrations in internal combustion piston engines having three or fewer cylinders is provided. The device includes a crankshaft having at least one detachable counterweight. The counterweight is a shiftable, torsional pendulum de-tuner. The pendulum de-tuner is configured to balance at least one order of acceleration of the crankshaft.

### FIELD OF THE INVENTION

The present invention relates generally to internal combustion piston engines. More specifically, the present invention is a torsional pendulum de-tuner device and system for engines having three or fewer cylinders.

### BACKGROUND OF THE INVENTION

Harmful torsional vibration in internal combustion piston engines caused by excessive crankshaft acceleration has been a problem for many years, decreasing the durability and hindering power output of engines. Each time a combustion event occurs in a cylinder, an instantaneous torque (or “torque spike”) is exerted on the crankshaft and a resultant pulse or excitation is transmitted to the crankshaft and anything downstream of it. Vibrations of different orders are produced at different speeds and with different engine configurations. As engine manufacturers have attempted to increase specific power output of engines, the problem has been amplified. In some applications, excessive crankshaft acceleration can cause torsional failures of the crankshaft. In other applications, excessive crankshaft acceleration decreases the service life of valvetrain components, drivetrain components, and tires, or necessitates that these components be made more robust. A common approach to resolving this problem is to increase the mass of the crankshaft assembly by adding a flywheel, or increasing the size of an existing flywheel. Adding mass to the crankshaft assembly increases the inertia of the crankshaft, thereby smoothing power delivery from the engine. In certain applications, increasing the number of cylinders in the engine is a viable solution, as the mass of the pistons and rods in the non-firing cylinders act in the same manner as a flywheel, by adding inertia to the crankshaft assembly.

The problem of excessive crankshaft acceleration is especially pronounced in engines having low-cylinder counts, such as three or fewer cylinders, as well as in engines having high power output. These types of engines are often used in recreational vehicles such as motorcycles, all-terrain vehicles, snowmobiles, smaller watercraft, and even generator sets. In engines having a large number of cylinders, the non-firing cylinders add inertia to the crankshaft assembly, smoothing power output. But as the number of cylinders in the engine decreases, that additional inertia is no longer present. For recreational vehicles, increasing the number of cylinders undesirably increases the cost, complexity, and/or size of the engine, and is typically an ineffective solution.

In order to provide smooth power delivery in recreational vehicle engines, a flywheel is typically added to the crankshaft, either attached on one end of the crankshaft, or integrated on one or more counterweights. As engine power output increases, larger flywheels are needed to maintain durability and usability. Yet as larger flywheels are introduced, the acceleration response of the engine is negatively affected due to the additional mass that must be accelerated with each rotation of the crankshaft. The engine will also rev slower, that is, be slower to accelerate from one speed to a higher speed. In addition, physically large flywheels create problems for packaging the engine in a chassis, as well as creating problems for manufacturing the crankshaft if the flywheel is integrated with a counterweight.

Consumers of recreational vehicles typically demand high output engines packaged in lightweight vehicles. High output, low cylinder count engines typically require more robust drivetrain components as well as more robust valvetrain components to withstand the torque spikes that occurs when each cylinder fires. Increasing the robustness of these components typically increases their weight as well, which is undesirable for performance of the vehicle. Adding mass to the rotating crankshaft assembly in order to dampen torsional vibrations is similarly undesirable, as discussed above. And in the special case of two-wheeled vehicles, increasing rotating mass in the engine can negatively affect the handling of the motorcycle.

As an example, engines currently used in cruiser-type motorcycles are typically very large displacement V-twins with an uneven firing order, and requiring an enormous flywheel in order to allow the engine to idle. Even with the large flywheels currently used, the magnitude of crankshaft accelerations experienced by the engine requires very robust driveline components in these motorcycles, increasing the overall weight of the vehicle. And consumers continue to demand higher power outputs, while retaining many of the characteristics of the V-twin configuration. A limit will be reached on the damping ability of a traditional flywheel in this application. Typical engines of this type feature a flywheel integrated into a counterweight, and as flywheel diameter is increased, aspects of manufacturing the crankshaft, become increasingly difficult and expensive.

A need exists in the recreational vehicle industry for an engine having smooth power output and lighter weight as compared to current configurations.

### SUMMARY OF THE INVENTION

The present invention provides various devices, methods and systems for damping torsional vibrations in internal combustion piston engines having three or fewer cylinders. A crankshaft is provided, having at least one detachable counterweight that comprises a torsional pendulum de-tuner. The pendulum de-tuner is configured to balance at least one order of acceleration of the crankshaft.

In one embodiment, the present invention comprises a device for damping torsional vibrations in internal combustion piston engines having three or fewer cylinders. The device includes a crankshaft having at least one detachable counterweight, the detachable counterweight being a shiftable swinging or oscillating torsional pendulum de-tuner. The pendulum de-tuner is configured to balance at least one order of acceleration of the crankshaft.

An advantage of the pendulum de-tuner of the present invention is that it is as effective at damping crankshaft acceleration of a given order as is a standard flywheel of a larger diameter. However, the size of the pendulum de-tuner crankshaft is smaller than a standard crankshaft, facilitating easier packaging in a chassis. Additionally, a crankshaft assembly having one or more pendulum de-tuners is lighter weight than a conventional crankshaft arrangement, thereby increasing power output and efficiency.

A further advantage of an engine utilizing a torsional pendulum de-tuner according to the present invention is that high-intensity torque pulses of the engine are reduced or stabilized. Reducing the instantaneous peak torque component while maintaining the average torque output allows the lightening of other components associated with the engine. For example, valvetrain components can be lightened, and drivetrain components such as transmission gears, belts, chains, and drive-wheel hubs can be lightened. Another advantage is that tire wear is decreased, and vehicle and engine longevity is increased.

A still further advantage of the present invention is that the manufacturing process for a crankshaft having detachable pendulum counterweights is simplified. Long-stroke crankshafts according to the present invention can be manufactured on typical automotive crankshaft production lines, thereby reducing the production cost of the crankshaft. Production steps such as crank pin grinding, fillet rolling, and oil passage drilling are easily facilitated by the present invention.

An advantage of the present invention is that a single crankshaft can be produced for multiple engines, such as a single crankshaft being used for two motors having the same stroke but different bores. In each application, different detachable pendulum de-tuners are used on the same crankshaft, so that in each application the crankshaft is properly balanced and damped, despite the difference in engine characteristics.

The above summary of the present invention is not intended to describe each illustrated embodiment or every implementation of the present invention. The following figures and detailed description more particularly exemplify the embodiments of the present invention.

### BRIEF DESCRIPTION OF THE DRAWINGS

The invention may be more completely understood in consideration of the following detailed description of various embodiments of the invention in connection with the accompanying drawings, in which:

FIG. 1 is a perspective view of a crankshaft including a torsional pendulum according to one embodiment of the present invention.

FIG. 2 is an end perspective view of the embodiment of FIG. 1.

FIG. 3 is a sectional view taken along the line 3-3 in FIG. 2.

FIG. 4 is an exploded view of the embodiment of FIGS. 1 and 2.

FIG. 5a is an end view of a pendulum at rest.

FIG. 5b is an end view of a pendulum in one phase of operation.

FIG. 5c is an end view of a pendulum in another phase of operation.

FIG. 6 is a perspective view of a crankshaft having multiple torsional pendulums according to another embodiment of the present invention.

FIG. 7 is a perspective view of a crankshaft having multiple torsional pendulums according to a further embodiment of the present invention.

FIG. 8 is an exploded view of the embodiment of FIG. 7.

### DETAILED DESCRIPTION OF THE DRAWINGS

In the following detailed description of the present invention, numerous specific details are set forth in order to provide a thorough understanding of the present invention. However, it will be apparent to one skilled in the art that the present invention may be practiced without these specific details. In other instances, well-known methods, procedures, and components have not been described in detail so as to not unnecessarily obscure aspects of the present invention.

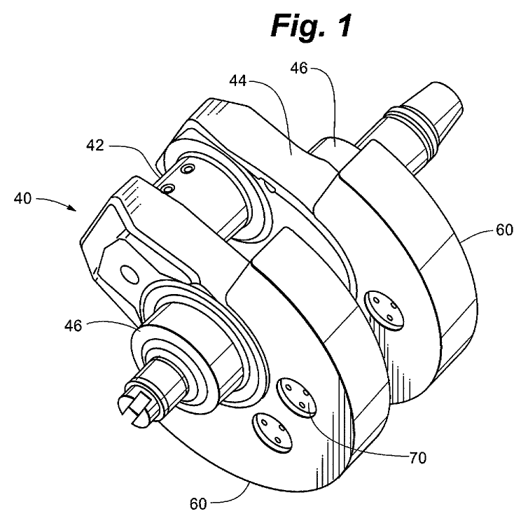

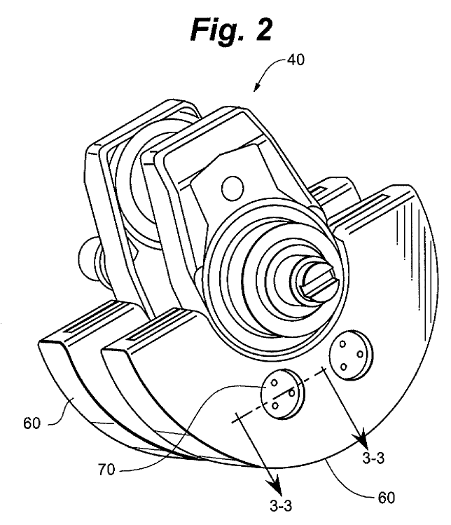

Referring to FIGS. 1-4, one embodiment of a crankshaft 40 is depicted such as for a two-cylinder engine. Although many of the example embodiments described herein and depicted in the Figures are in reference to a two-cylinder engine, it should be understood that the present invention is applicable to multi-cylinder engines, especially those having three or fewer cylinders.

Crankshaft 40 includes rod journal 42, crankwebs 44, main journals 46, and pendulum attachment portion 48, having web bores 50.

Pendulum 60 comprises a detachable counterweight for crank 40, and includes a receiving portion 62 and bores 64. Pendulum 60 is configured to be detachably coupled to crankshaft 40, specifically to attachment portion 48. In one embodiment depicted in the figures, attachment portion 48 comprises a male half, while pendulum 60 comprises a female half. In another embodiment (not pictured), attachment portion 48 comprises a female half while pendulum 60 comprises a male half. Each of crankshaft 40 and pendulum 60 may be forged, cast, billet, or of other suitable constructions.

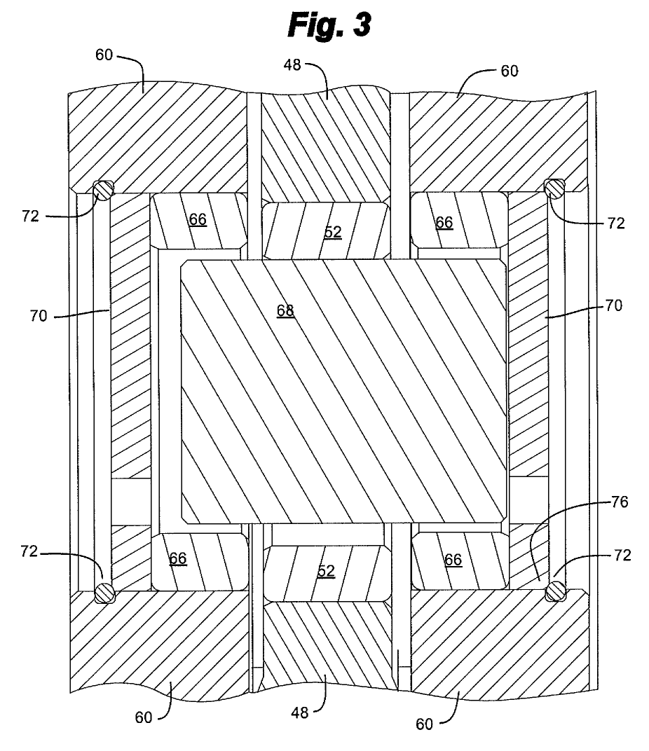

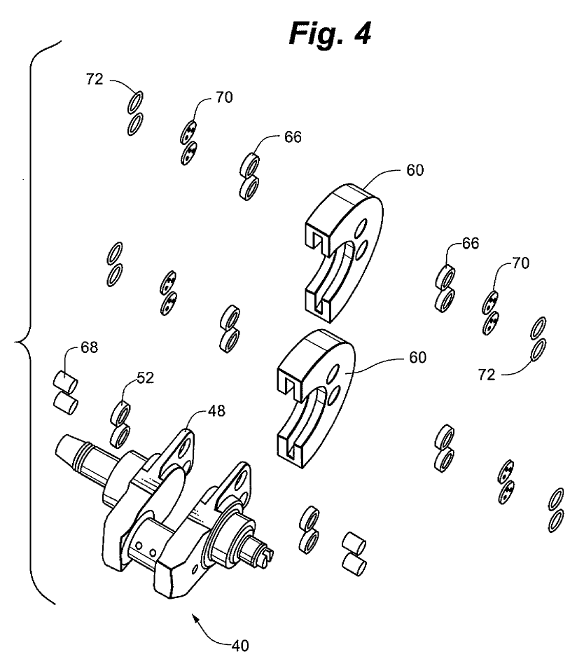

To couple pendulum 60 to crankshaft 40, a pin 68 is provided. Referring to FIGS. 3-4, pin 68 is inserted through a bore 50 and a bore 64. In one embodiment, bearings 52 are provided in crankshaft 40, and bearings 66 are provided in pendulum 60, such that pin 68 rolls within the bearings. In order to secure pin 68 within pendulum 60, a cap 70 and retention ring 72 are provided on each side of pin 68. Cap 70 is partially inserted into bore 64, and retention ring 72 is inserted until ring 72 engages with groove 74 in pendulum 60. Cap 70 may include a circumferential chamfered edge 76 to interfere with retention ring 72. In such an embodiment, if cap 70 is urged away from pin 68, chamfered edge 76 becomes wedged against ring 72, tightening the junction therebetween.

Pendulum 60 includes a number of characteristics that can be chosen, adjusted, or otherwise modified to dampen a desired order of vibration. An order is defined as occurring per revolution of crankshaft 40, for example a half-order occurs every two revolutions of crankshaft 40, while a fourth-order occurs four times per revolution. Different engine design parameters, such as number of cylinders, crankpin arrangement, inline, opposed or V-type, angle between cylinders in a V-type, and so forth, can have an effect on what the dominant orders of a particular engine are. The natural frequency of pendulum 60 during rotation is a constant multiple of the revolutions per minute of crankshaft 40. The order to which a pendulum 60 is tuned to depends on a number of characteristics including one or more of the following: the distance between the axis of rotation of crankshaft 40 and the center axis of bore 50, the distance between the axis of rotation of crankshaft 40 and the effective axis of suspension of pendulum 60, the relationship between the diameter of bores 50, the diameter of bores 64, and the diameter of pin 68, the mass and/or center of gravity of the crankweb, and the mass and/or center of gravity of the pendulum.

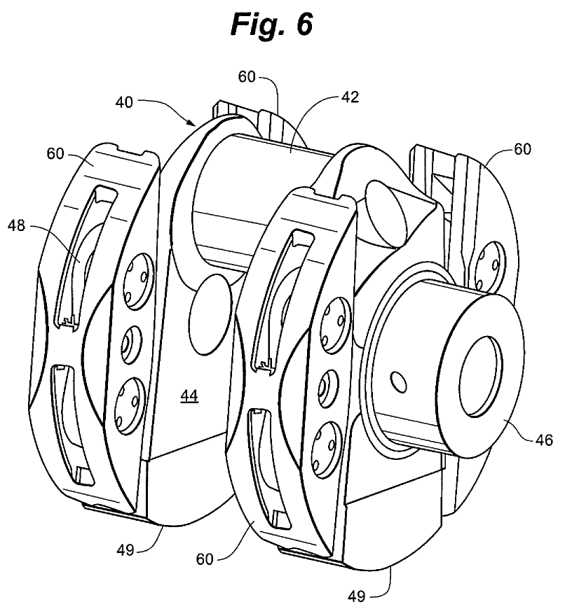

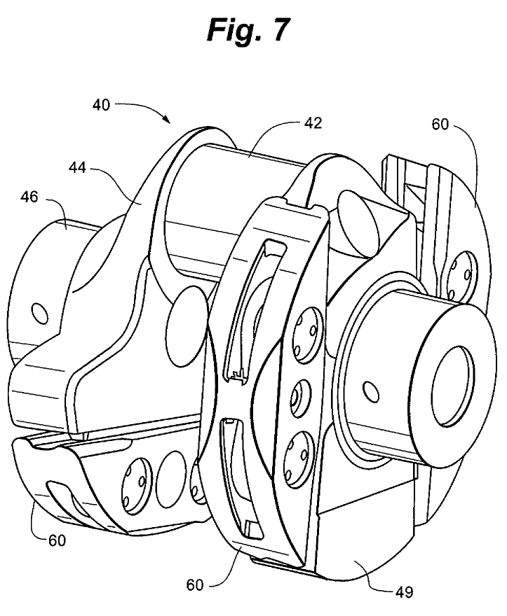

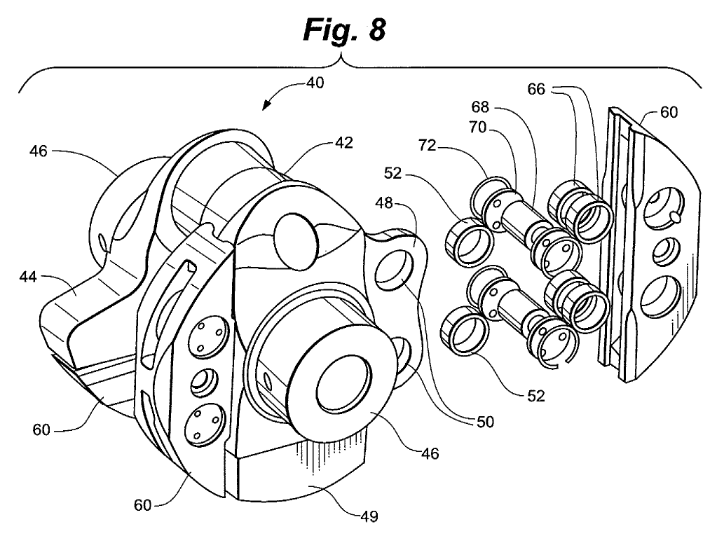

A single pendulum 60 may be tuned to dampen only one order of vibration. Fortunately, many engine configurations exhibit a very few dominant orders of torsional excitation which cause most of the instantaneous torque component. In one embodiment such as depicted in FIGS. 6-8, one or more pendulums are provided and configured to dampen the most dominant orders of the engine. When pendulum 60 is tuned for a particular order, the pendulum is as effective as a large flywheel, but only for that particular order.

In one embodiment, crankshaft 40 is provided with multiple pendulums 60, so as to dampen multiple orders of vibration. In one arrangement, a pendulum 60 is included on each crankweb 44. In a further arrangement, more than one pendulum 60 is included on one or more crankwebs 44. The addition of multiple pendulums 60 may affect the balancing of crankshaft 40. However, crankweb 44 may include a stationary balance weight 49 as depicted in FIGS. 6-8, to achieve proper balancing of crankshaft 40. Balance weight 49 may be constructed from a material denser than crankshaft 40.

In operation, pendulum 60 is used to attenuate unwanted vibrations occurring from torque pulses associated with combustion events in an engine. Pendulum 60 acts as a dynamic flywheel, that is, for a particular order of vibration that pendulum 60 is tuned to react to, pendulum 60 can have the same effectiveness of a flywheel many times its physical size, but without the drawback of the added inertia of a crankshaft with such a large flywheel. Pendulum 60 acts to add inertia back into the crankshaft system when the pendulum is excited at the order it is tuned for, much in the same way that a large flywheel is used to store and release energy. Pendulum 60 may be tuned to dampen different orders of vibration by changing one or more characteristics of the pendulum. In one embodiment, altering the relationship between the diameters of crankweb bores 50, pendulum bores 64, and pins 68 provides a method for changing the damping characteristics of pendulum 60.

Pendulum 60 physically moves to counteract the specific disturbance that it is tuned to remove. Pin 68 interacts with pendulum bore 64 to facilitate the swinging of pendulum 60 from crankweb bores 50. The amount of oscillation of pendulum 60 (or the angle that pendulum 60 rolls) is proportional to the input characteristic of the torque. Pendulum 60 automatically adjusts its phase and amplitude to counteract the particular externally applied torque component by the crankshaft mechanism. This action smoothes the torque signature of the engine, making it more analogous to an electric motor output rather than an air-impact type of torque.

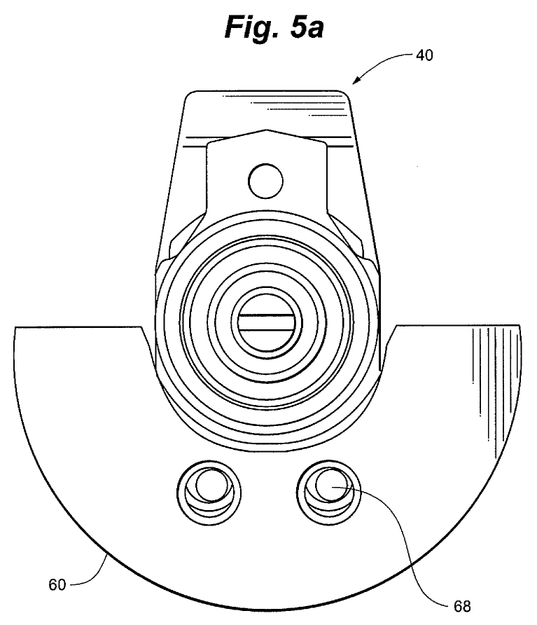

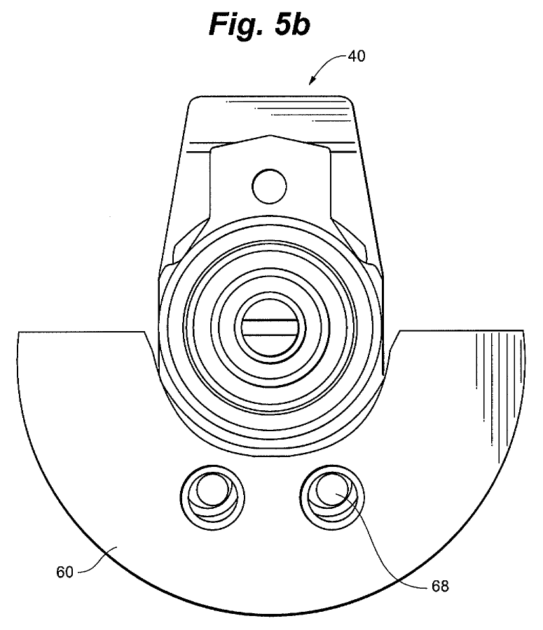

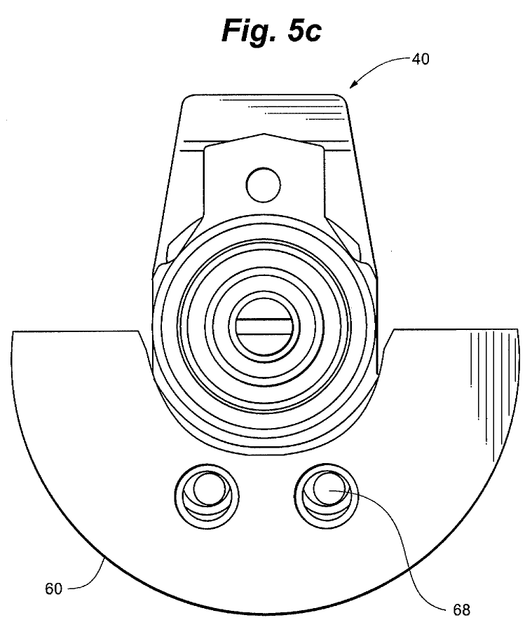

Referring now to FIGS. 5a-5c, pendulum 60 is depicted in various operating positions (with caps 70 removed for clarity). In FIG. 5a, pendulum 60 is at rest, in an undisturbed position. FIGS. 5b and 5c depict pendulum 60 in its range of motion, as can be seen by the position of pins 68 with respect to bearings 52 and 66.

A number of surprising and unexpected results are associated with the present invention. These results include the ability to reduce the robustness of components associated with the engine and drivetrain; improved manufacturing processes for the crankshaft; improved traction for recreational vehicles implementing the present invention; and improved handling in motorcycles.

When a combustion event occurs, torque spikes are transmitted into crankshaft 40, causing vibrations that affect crankshaft 40 and all the components downstream of crankshaft 40. These downstream components can include valvetrain components, drivetrain components, and engine-driven accessories. To withstand these cyclical vibrations, components downstream of the crankshaft typically have had to be overly robust. By providing a crankshaft 40 having one or more pendulums 60, the power output of the engine is smoothed, reducing the amplitude of the torque spikes. A smoother engine power output allows downstream components to be made less robust, and therefore lighter weight. Lighter weight componentry desirably affects the power to weight ratios of recreational vehicles. The present invention allows for recreational vehicles having lighter weight components, thereby improving vehicle performance.

Valvetrain components are driven by the crankshaft, and excessive acceleration of the crankshaft caused by instantaneous torque spikes will translate directly into the valvetrain, including the cam chain/belt, and valve springs. An engine according to the present invention having a crankshaft 40 with one or more pendulums 60 can be used to provide a smooth engine power output, minimizing the effect of torque spikes on valvetrain components. In one embodiment, a vibration order causing excitation in the valvetrain is identified, and pendulum 60 is tuned to dampen the order originating from the crankshaft.

Drivetrain components such as clutches, transmission gears, drive chains or belts, cush drives and wheel hubs, and torque-compensating devices can be reduced in size and therefore lightened, increasing overall vehicle performance. In addition, a smoother engine power output as provided by the present invention improves operation and reliability of these components, as well as reducing noise. For example, currently certain recreational vehicles like cruiser-type motorcycles implement complex and heavy torque-compensating devices to limit the stresses felt by the transmission from the crankshaft torque spikes. The present invention reduces the need for such torque-compensating devices by damping vibrations occurring in the engine. Additionally, transmission shifting is improved with the present invention, as undamped excitations reaching the transmission cause gear dogs to impact one another, rather than sliding from one gear to the next.

Crankshaft-driven accessories such as oil pumps, water pumps, and alternators, can similarly benefit from the present invention. Electrical output from alternators should exhibit less flicker in low engine rpm operation.

In addition to the dynamic benefits of a crankshaft 40 having a pendulum 60, there are a number of manufacturing advantages as well. Many crankshafts used in recreational engines are forged, for improved strength. This process requires the impact forming of a quantity of material into the complex shape of a crankshaft, using specialized equipment. Recreational engine crankshafts are produced in very small quantities as compared to automotive crankshafts, and cost savings are possible if the recreational engine crankshafts can be manufactured with the same equipment as is used for automotive crankshafts.

However, certain crankshaft designs such as for V-twin cruiser motorcycles, utilize large diameter flywheels integrated into the crankshaft counterweights. The large size of such crankshaft designs prohibits them from being manufactured on automotive forging equipment, thereby increasing manufacturing costs. A crankshaft 40 according to the present invention having a detachable pendulum 60 can be more easily manufactured on automotive forging equipment.

The present invention further simplifies a number of crankshaft manufacturing processes such as fillet rolling (to impart compressive stresses into the material in high stress areas), pin grinding, and oil passage drilling. In crankshafts having large diameter counterweights, or in long-stroke crankshafts, access is restricted for fillet rolling equipment to reach all sides of the crankpins.

However, in the present invention, the counterweights are detachable, in the form of pendulum 60. Crankshaft 40 can be manufactured and finish machined prior to coupling pendulum 60 thereto. This allows sufficient machining access to all areas of crankshaft 40.

In one embodiment, crankshaft 40 can be formed by casting. Because of superior access for fillet rolling equipment, cast crankshaft 40 can be manufactured to withstand higher stresses than other cast-manufactured crankshafts with limited fillet rolling access. In another embodiment, crankshaft 40 is forged, and pendulum 60 is cast.

In one embodiment, the present invention comprises a composite crankshaft, wherein a high strength, high cost material is used to manufacture crankshaft 40, while a lower strength yet cheaper material is used to manufacture pendulum 60.

The present invention may also improve tire traction and tire wear in some applications. By implementing pendulum 60 into a recreational vehicle engine and smoothing the torque spikes otherwise ordinarily transmitted through drivetrain and into the tire, traction may be improved and tire wear reduced.

In addition, tire traction is sometimes compromised as a result of vibrations. In the case of motor sports applications such as drag racing and road racing, tire excitation due to vibration contributes to a decrease in available traction from the tire. This decreased traction is undesirable for achieving maximum performance of the vehicle, such as off-the-line acceleration in drag racing, or corner exit during road racing. Certain of these vibrations occurring in a tire may be a direct result of un-damped crankshaft vibrations. In such a case, pendulum 60 can be provided and tuned to one or more orders of engine vibration that is causing the tire excitation, thereby improving traction. This can have significant benefits for recreational vehicles used in motor sports, as well as vehicles under normal operating conditions.

Further, the use of a crankshaft 40 having one or more pendulums 60 according to the present invention may also improve the handling of motorcycles. Because the crankshaft is rotating during operation of a motorcycle, depending on the engine configuration (such as longitudinal, transverse, and direction of rotation), the handling of the motorcycle may be subject to gyroscopic effects from the crankshaft. As discussed above, the present invention provides a crankshaft 40 having a lower moment inertia than previously possible. This reduction in rotating mass may have a positive effect on the handling of a motorcycle by not interfering with gyroscopic effects of the wheels of the motorcycle.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A device for damping torsional vibrations in internal combustion piston engines having three or fewer cylinders, comprising:
a crankshaft having at least one detachable counterweight, the detachable counterweight being a shiftable, torsional pendulum de-tuner, the pendulum de-tuner being configured to balance at least one order of acceleration of the crankshaft.

2. The device of claim 1, wherein the crankshaft is constructed of a first material and the detachable counterweight is constructed of a second material.

3. The device of claim 1, wherein the crankshaft is forged.

4. The device of claim 3, wherein the detachable counterweight is cast.

5. The device of claim 1, further comprising a second detachable counterweight pendulum de-tuner, wherein each pendulum de-tuner is attached to separate crankwebs of the crankshaft.

6. A method for damping torsional vibrations in internal combustion piston engines having three or fewer cylinders, the method comprising:
providing a crankshaft having at least one detachable counterweight;
forming the detachable counterweight as a torsional pendulum de-tuner; and
configuring the pendulum de-tuner to balance an order of acceleration of the crankshaft.

7. An engine, comprising:
three or fewer cylinders;
a crankshaft; and
at least one detachable counterweight coupled to the crankshaft, the detachable counterweight being a torsional pendulum de-tuner configured to dampen one order of acceleration of the crankshaft.

8. The engine of claim 7, wherein the crankshaft comprises a forged long-stroke crankshaft.

9. A method for reducing undesirable tire excitation in a vehicle powered by an internal combustion engine having a crankshaft, the method comprising:
identifying an order of acceleration of the crankshaft contributing to the undesirable tire excitation;
providing a detachable counterweight for the crankshaft, the detachable counterweight being a torsional pendulum de-tuner; and
configuring one or more characteristics of the torsional pendulum to dampen the identified order of acceleration contributing to the undesirable tire excitation.

10. A recreational vehicle having an internal combustion engine, comprising:
three or fewer cylinders;
a crankshaft; and
at least one detachable counterweight coupled to the crankshaft, the detachable counterweight being a torsional pendulum de-tuner configured to dampen one order of acceleration of the crankshaft.
